(19) United States
(12) Patent Application Publication
(10) Pub. No.: US 2017/0173459 A1
(43) Pub. Date: Jun. 22, 2017

(54) Online Remote Game System

(71) Applicant: Maurice MILLS, Renton, WA (US)

(72) Inventor: Maurice MILLS, Renton, WA (US)

(21) Appl. No.: 15/127,242

(22) PCT Filed: Mar. 19, 2015
(86) PCT No.: PCT/US2015/021548

§ 371 Date: Sep. 19, 2016

Related U.S. Application Data
(60) Provisional application No. 61/955,587, filed on Mar. 19, 2014.

(51) Int. Cl. A63F 13/33; A63F 13/52; A63F 13/80; A63F 13/79; A63F 13/35

(52) U.S. Cl. CPC A63F 13/33; A63F 13/79; A63F 13/35; A63F 13/80; A63F 13/52

(57) ABSTRACT

An on-line game system includes a table with an attendant and a plurality of seats assigned to at least one a remote player and one or more live players or to a plurality of remote players. Remote players connect to the system via a wide area network. Located at each seat is a private camera that transmits images of face down game objects on the table. A public camera transmits images of all face up game objects on the table. A table camera is used to transmit images of the table and attendant. A RFID reader, a barcode reader or OCR software program are used to determine the identities of the game objects. Each game object also includes a wireless receiver and a physical signaling element that is activated when selected by the remote player. Remote players instruct the attendant to move game objects on the table during the game.

### TECHNICAL FIELD

This invention relates to table or board games played with cards, tiles, dominoes or other physical game objects that must be selected and moved on the table or board by the players, and more particularly to such games that are played by remote players.

### BACKGROUND ART

A variety of games are classified as table or board games because the players sit or stand around a table or a board at designated locations. Many table or board games require players to select various game objects on the table or board and move them to different areas.

Many live card games are now played at a specific location by players at the table and remote players. Such a card game system specifically designed for poker was developed by the inventor and disclosed in U.S. Pat. Nos. 7,727,060 and 8,672,735 which is now incorporated by reference herein.

Of all the online table games that are in use, one aspect of game play involves random shuffling, distribution, selection and movement of game objects. Current online games, such as Mahjong, Cribbage, Gin Rummy, and dominoes, utilize a Random Number Generator wherein virtual game objects are generated by a game-system. Physical game objects are not used. In this manner, current online games do not accurately simulate the land-based environment and many players choose not to play or recognize the online version of the game.

In card games such as poker, the cards are dealt individually to the players around the table. The player's play the cards dealt to them and cannot select other cards to build a winning hand. During the game, the players are not required to pick a card from a pile of cards on the table. Remote players are also not required to instruct the dealer to move a card from one pile to another on the table

### DISCLOSURE OF THE INVENTION

It is an object of the present invention to provide a land-based, online game system played by live and remote players at a physical game table that requires the selection and movement of physical game objects on the game table.

It is another object of the present invention to provide such a game system that allows remote players to select specific game objects located on the game table and communicate the selection to a dealer.

It is another object of the present invention to provide such a game system that allows remote player to indicated the selected game object to a dealer, hereinafter called an attendant, and then instruct the dealer to move the game object to a desired location on the game table as required in order to play the game.

These and other objects of the invention are met by the land-based, online game system discussed herein that uses a table operated by a live attendant who distributes game objects to live players sitting or standing at the table and to remote players who participate in the game via a wide area network. The system allows the live players and the remote players to play against each other at the table and remote players to play against other remote players.

The table is divided into designated seats that are individually assigned to the live and remote players. Located at or near each designated seat is a private camera designed to transmit images of the ‘face down’ game objects dealt to the designated seat. Located above the table is at least one public camera that provides images of the section of table where the ‘face up’ objects are distributed. Also mounted at or above the table is at least one table camera designed to provide a wide angle image of immediately around the attendant where the public and private game objects are handled and distributed.

The images from the private camera are privately transmitted to the remote player assigned to the designated seat. The images from the public camera and table camera are transmitted to the game server, and to all of the remote players via the wide area network. While the use of both a public camera and a table camera is preferred, it should be understood that the functions of the two cameras may be incorporated into one or more modified table cameras with a wide angle lens which allows the entire or large sections of the table and the attendant to be seen.

Each game object used in the game is assigned an identification code. The system also provides a means to verify the identity of the public and private game objects. In the first embodiment, the means for verifying the identity of the public and private game objects is an identifying radio frequency identification device (hereinafter referred to as an RFID tag) attached to the game object. Located near the attendant or each designated seat is a RFID tag detecting device. During a game, the RFID tag on each game object is detected by one of the RFID detective devices. When detected, the system records the identification code assigned to the game piece. The game management software program then notes the location of the game object and the identity of the player possessing the game object. In some instances, the system is designed to transmit the identification code to the remote player's computer and presented it on the remote player's display. During a hand, the remote player is able to view both the live images of the table, the playing area, and the movement of the game objects. The system also provides a description of the moving game object to the remote player's display.

In one embodiment, the RFID tag and RFID detective device may be replaced with a barcode imprinted onto the game object and barcode reader. The barcode reader may be a separate hardware device or it may be the private camera that transmits images of the private game object to a computer with a barcode reading software program that reads and interprets the barcodes on the game objects. The computer may be a separate computer or the game server.

In another embodiment, means for verifying and recording the game objects is a scanner or the second private camera coupled to a computer with OCR software program loaded into its memory. The OCR software program is able to read the numbers, symbols and images on a game object. The OCR software program converts the data into computer code, which can be stored on the game management program and sent to the remote player's display.

In all three embodiments, the identification or description of the game objects played during a hand are automatically recorded. If a misdeal occurs, the recorded information may be reviewed. During play, each remote player reviews the images of the game objects in a viewer window and the descriptions of the game objects shown therein. The images of the game objects and the written descriptions of the game objects should match. If they do not, then a misdeal has occurred and the attendant is notified immediately.

During play, the movement of the attendant's arms and hands are closely watched by all players as the game objects are distributed. In the improved invention, the means for detecting and verifying the identity of the public and private game objects are located at positions on the table so that attendant may pass the game objects directly over the readers using standard arm and hand movements. When the RFID readers or and barcode readers are used, the RDID readers and the barcode readers may be built into the table near the transparent panels. The readers are located near the attendant. With a game object detection, the RFID reader or barcode readers may be built directly into the transparent panel so that when the game objects are deposited onto the transparent panel, the images of the game objects and the verification information are simultaneous recorded and shown on the remote player's display. With the public cameras, a separate RFID device or barcode reader may be located in the area of the table between the attendant and the designated public area. If game objects with RFID tags are used, the RFID device may be built into the table adjacent to the designated public area. The images of the game objects and the verification information are simultaneous recorded and sent to the game server.

The system includes a game server with a game managing software program loaded therein. The game managing software program enables the game server to act as a state machine capable of managing at least one game played between the live players and the remote players, or between the remote players. The system also includes a web server that connects the game server to the wide area network and to each remote player's personal computer. The system further includes a database server that stores each remote player data file and the specific game information files.

During a game, the attendant may use an attendant computer located near or adjacent to the table to monitor and receive instructions from the remote players. Loaded into the working memory of the attendant computer is an attendant side software program capable of inputting and receiving the remote player's instructions from the remote players and other data from the game server.

The remote player data file contains the remote player's personal information, his or her user name, and his or her password. When a remote player logs onto the system using his or her remote computer, a client side software program may be loaded into the working memory of the remote computer which automatically checks for software program updates and verifies the remote player's username and password. Alternatively, the remote player may include a browser that allows the remote player to log into a website. A plug-in software program may be needed to allow the browser to receive files from the website. During setup, each player has a remote player data file which includes a funds sub-file from which bets or winnings are withdrawn or deposited.

When the client side software program is activated on the remote player's computer, or when the user logs into the game operator's website, a list of tables and games currently being played or available are displayed. This list is presented in a simulated image of a game room lobby, hereinafter called a lobby menu. Shown on the lobby menu is a list of games (i.e. Mahjong, Gin Rummy, Dominoes, Cribbage, etc.) that are currently being offered. Accompanying the list of games may be the name of the table, the number of open seats currently available at each table, and the number of players currently seated at each table. After reviewing the information on the lobby menu, the remote player then selects a game and a specific table.

After the remote player's log-on information has been verified by the server or website, and the balance in the player's funds sub-file is checked, an image from the selected table is presented on the remote player's display showing the location of one or more available seats. Once the seat is selected, images from the private camera, the public camera and the table camera are then automatically transmitted via the wide area network and displayed. The images from the cameras discussed above are shown in individual areas or windows on the display. Also provided on the display is a game action menu with input buttons that enable the remote player to transmit instructions to the attendant regarding the disposition of his or her game objects or whether the player elects to hold, place a bet, or fold if betting is available in such game. An optional chat window or audio/video feed may be transmitted to the remote player's display or computer that allows the remote player to communicate with the attendant and/or the other live or remote players during the course of the game.

An important aspect of the system is the use of a live attendant who shuffles and distributes game objects, is visible at all times to the remote players. The attendant may use an automatic shuffler, which are available for Mahjong tiles. Because the game objects are distributed to the occupied designated seats around the table, the need for a random number generator commonly used with online games found in the prior art is eliminated.

Another important aspect is that when private game objects are distributed to each occupied designated seat, the private camera automatically transmits images of the game objects to the remote player assigned to the designated seat. The means for verifying the private game object identity simultaneously produces a written description of the game object on the remote player's display. When public game objects are distributed in the center of the table or to the designated seats, their images are also visible to everyone including all the remote players. When game objects are stacked or placed in a pile by the attendant, a graphical representation of the stack or pile is transmitted to each remote player with object in the same position as they are at the physical table. A means for verifying the public game object identity simultaneously produces a written description of the public game object on the display. The combined use of private object images, public object images, live table object images, verification of the private and public game objects, allows the system to be used in both live to live player games, live to remote player games, and in remote player to remote player games.

In some games, the remote players must select specific game objects. The table is staffed with a live attendant who moves the game objects for all the remote players connect to the system via a wide area network. At each designated seat is a private camera that transmits images of the face down game objects delivered thereto. A table camera transmits live images of the attendant and the surrounding table area where the game objects are placed. The game server renders and transmits a graphical representation of the location and position of the physical game pieces to each remote player's display. During the course of a game, the remote players may select remotely various game objects on the game table that require movement by the attendant. In the embodiment shown herein, the game action menu includes player control buttons associated with actions or instructions to be sent to attendant. The nature of actions or instructions associated with the buttons is dependent on the nature of the game and controlled by the game server.

The game objects include a wireless identifier that can be identified by the system that enables the game objects to be tracked by the game server. Each game object also includes a wireless receiver coupled to a physical signaling element that when activated generates a sound, a light or a vibration detectable by the attendant. When a remote player selects a game object on their display, a signal is sent from the remote player's computer to the game server. The game server then transmits a wireless signal to the selected game object causing activation of the physical game element. When detected, the attendant then physically moves the activated game object to the remote player's designated seat location or the discard pile,

### BRIEF DESCRIPTION OF THE DRAWINGS

FIG. 1 is a diagram of the land-based, online game system in accordance with the present invention.

FIG. 2 is an illustration of a remote player's computer and display.

FIG. 3 is an illustration of the log-on menu used by the remote player to sign into the system.

FIG. 4 is an illustration of the menu page presented on a remote player's display showing the various games available to a remote player when they log onto the system.

FIG. 5 is an illustration of a game action menu page showing the table where a Mahjong game with four remote players assigned to designated seats and live attendant standing next to the table.

FIG. 6 is an illustration of a game action menu page similar to the menu page shown in FIG. 5 where a game of Cribbage played with two 2-player teams assigned to designated seats and a live attendant standing next to the table.

FIG. 7 is a sectional side elevational view of a designated seat showing the location of the transparent panel, the RFID device, and the private camera.

FIG. 8 is an illustration showing a deck of playing cards with an identifying RFID chip embedded on each card that is passed through an RFID detecting device and then transmitted to the remote player's computer and display.

FIG. 9 is an illustration showing a section of the table with a scanner located at or near a designated seat that is coupled to a remote player's computer and display.

FIG. 10 is an illustration showing a bar code scanner being used to read an identifying bar code imprinted onto the surface of a playing card.

FIG. 11 is an illustration of a table with four remote players playing a Mahjong game and showing the attendant physically moving an activated game piece.

FIG. 12 is an illustration of a table with four remote players similar to the illustration shown in FIG. 11 playing Cribbage and showing the attendant physically moving an activated playing card.

FIG. 13 is an illustration showing a remote player connected via his or her remote computer and a wide area network to the web server and game server and playing an online Mahjong game wherein the images and identities of the public and private game objects are transmitted to the remote player and stored in the game server.

FIG. 14 is a partial top plan view of table showing a modified designated player area that includes a transparent panel and a public camera located under the transparent panel with a RFID antenna constructed in the transparent panel or the table.

FIG. 15 is a sectional side elevational view of a designated seat showing the location of the transparent panel and the private camera.

FIG. 16 is an illustration showing the attendant moving a game object with the activated physical indicator to the remote player's designated playing area.

FIG. 17 is a front plan view of a modified Mahjong game object with a RFID chip, a wireless receiver, and an LED bulb located along its edge.

FIG. 18 is a front play view of a set of modified playing cards with a RFID chip, a wireless receiver, and an LED bulb located along its edge.

### BEST MODE FOR CARRYING OUT THE INVENTION

Referring to the accompanying Figs. there is shown a land-based, online game system, generally referenced as 10, specifically designed to allow live player to live player, live player to remote player, and remote player to remote player, to a play a game that requires the selection and movement of game objects. The system 10 includes a table 12 with a live card attendant 15 assigned thereto. The table 12 is divided into a plurality of designated seats (four seats shown and denoted 20A-D) that are individually assigned to one or more live players (not shown) and to one or more remote players 17 A-D.

During a game, the attendant 15 consecutively distributes game objects to live and remote players assigned to designated seats 20A-D. The game objects can vary dominoes, or playing cards. Some games require the distribution of ‘face down’ game object so to each designated seat and are called ‘private game objects’ 22. In the center of the table 12, distributed game objects are called ‘public game objects and indicated by reference number 24. During a game, each player uses the private game objects 22 and public game objects 24.

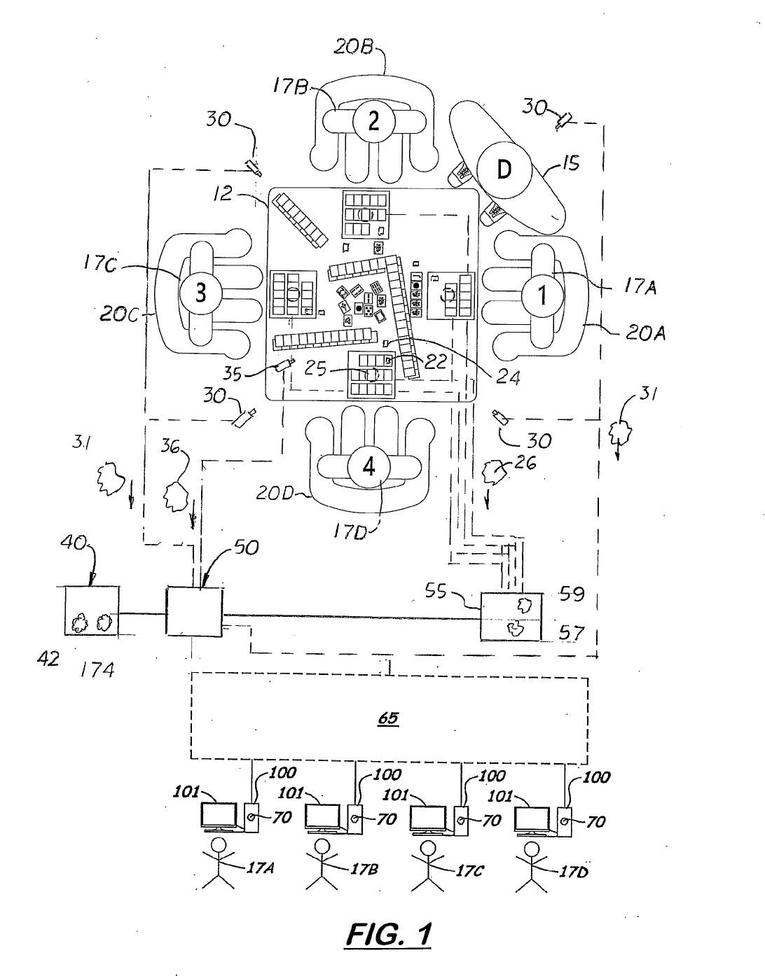

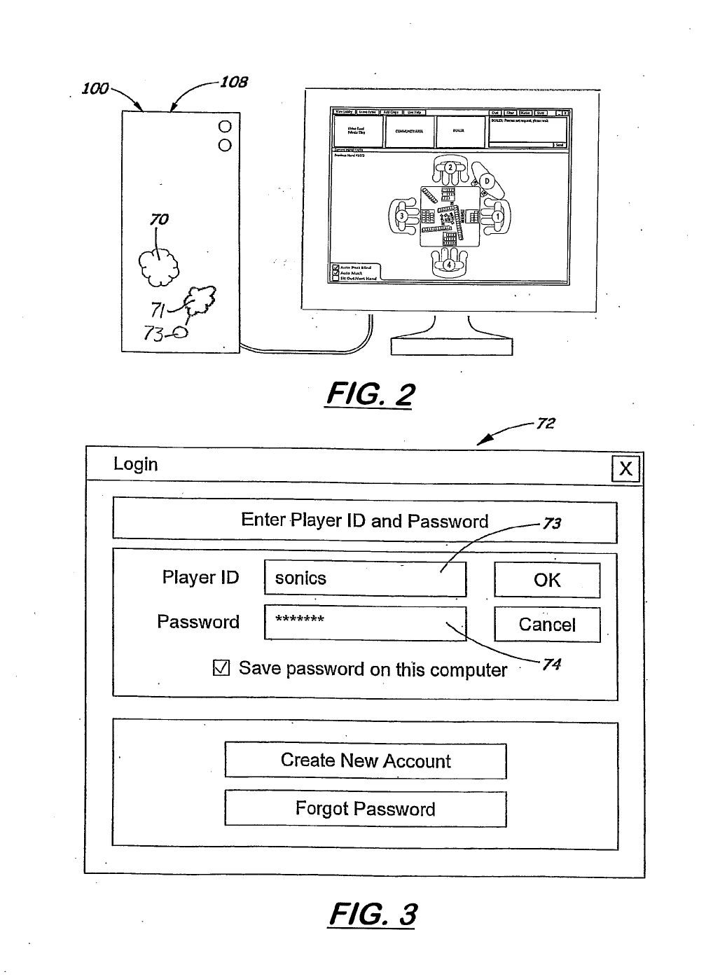

As shown in FIG. 1, located at or near each designated seat 20A-D is a private camera 25 designed to transmit live images 26 of the private game objects 22 dealt to a remote player 17A-D assigned to one of the designated seats (20A-D). The live image 26 of the private game objects 22 produced by the private camera 25 is instantaneously transmitted via a wide area network 65 to the display 101 connected to a computer 108 operated by the remote player 17A-D assigned to the designated seat 20A-D, respectively. The image 26 is displayed in a particular area, called a private game object window 114 on the remote player's display 101 as shown in FIG. 2 and as described further below.

Mounted at or above the table 12 or above each designated seat 20 A-D, is a public camera 30 designed to provide an image 31 of the public game objects 24 dealt on the table 12. In FIG. 1, there are four public cameras 30 placed around the table 12. It should be understood that the number of public cameras 30 may vary depending on the type of games played and the number of seats. In the preferred embodiment, the image 31 from the public camera 30 is also transmitted to all of the remote players 17A-D. The image 31 from the public camera 30 is presented in a public card window 116 on the remote players' display 101 also as shown in FIG. 2 and described below.

Mounted at or above the table 12 is a table camera 35 designed to provide a wide angle image 36 of the entire or a portion of the table 12 and attendant 15 to each remote player 17A-D. During a name, an image 36 of the entire table 12 and the attendant 15 is transmitted to each remote player 17A-D enabling him or her to verify that the deck 21 of playing game objects is distributed correctly and that the live players sifting around the table 12 are not cheating. The image 36 produced by the table camera 35 is presented in a table camera window 118 on the remote player's display 101 as shown in FIG. 2 and described below.

Attached or mounted on the table 12 is an optional means for verifying the identity of the private game objects 22 dealt to the designated seats 20 A-D. As discussed further below, the means for verifying the identity of the private game objects 22 is the use of a deck of playing cards or game objects 130 each with an identifying RFID tag 140 attached thereto. Mounted above the table 12 (see FIG. 1) or near each designated seat 20A-D is a RFID detecting device 142 through which each game object 130 is swiped before being dealt to each designated seat 20 A-D. An identification code 143 is assigned to each RFID tag 140 that is then transmitted via the wide area network 65 to the computer 100 operated by the remote player 17A-D assigned to one of the designated seats 20 A-D.

In one embodiment, a client side software program 70 loaded into the remote player's computer 100, processes the identification code 143 and then presents the simulated image 119 of the game object 130 on the remote player's display 101. In another embodiment, the RFID detecting device 142 is connected to a game server 40 which then presents a simulated image and/or a written description of the game object to the remote players' display. By comparing the live images 26 from the private camera 25 with the simulated images 119 and the written descriptions 117 of the playing game objects 130, each remote player 17A-D is able to verify that the playing game objects actually dealt are being played.

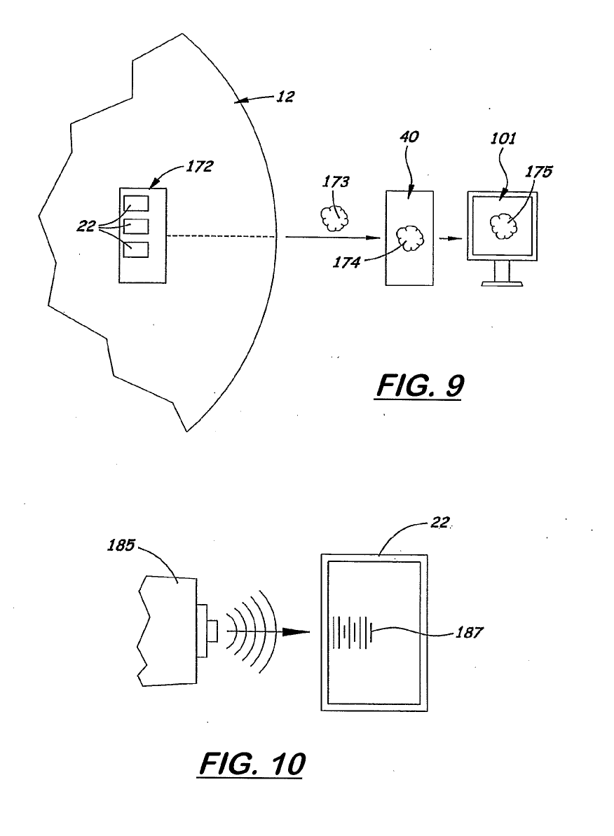

It should be understood that the means for verifying the identity of the private game objects 22 may also be a standard set of playing game objects 21 and a scanner 172 built into or assembled on the table 12 or adjacent to each designated seat 20A-D as shown in FIG. 9. When the game object is a standard playing card 21 is dealt to the designated seat 20A-F, it is first passed over the scanner 172 and read. An OCR software program 174 located into the memory of the game server 40 discussed further below converts the digitalized scanned file 173 of the playing card 21 into a readable image file 175 capable of being transmitted and displayed on the private card window 114 on the remote player's display 101.

Shown in FIG. 10, a third alternative method for verifying the game objects is disclosed that uses a barcode imprinted set of game objects each with an identifying barcode 187 on a surface back that is read by a barcode reader 185 located on the table 12.

The system 10 includes a game server 40 with a poker game managing software program 42 loaded therein as shown in FIG. 1. The game managing software program 42 enables the game server 40 to act as a state machine capable of managing a game played between live players 16A, 16B, between live players 16A, 16B and remote players 17A-D,or between only remote players 17A-D. The system 10 also includes a web server 50 that connects the game server 40 to a wide area network 65, and a database server 55 that stores the remote player data files 57 and specific game information files 59.

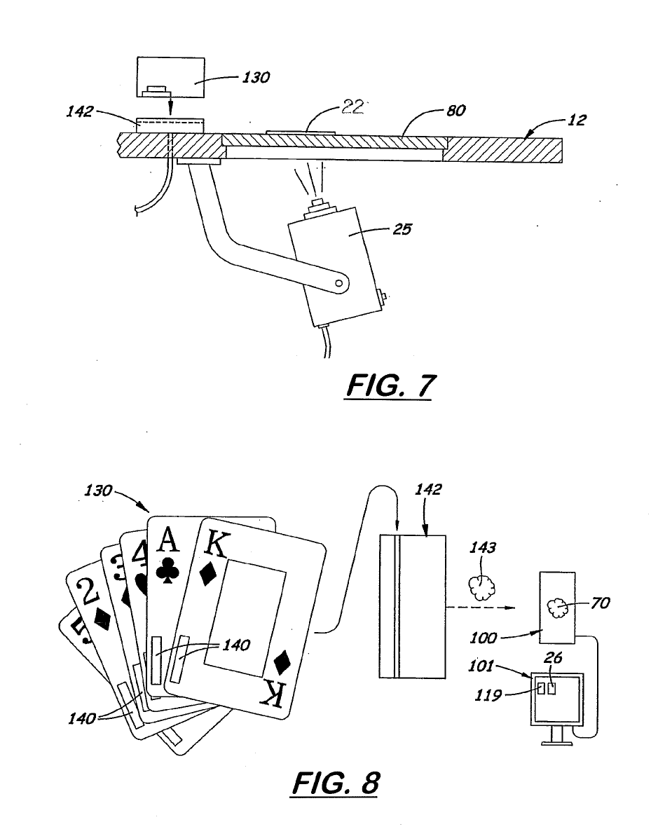

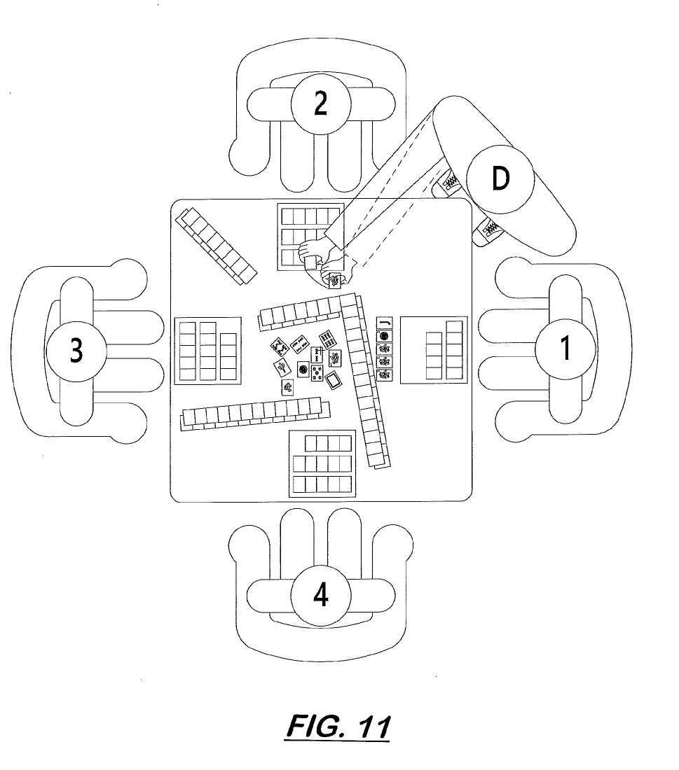

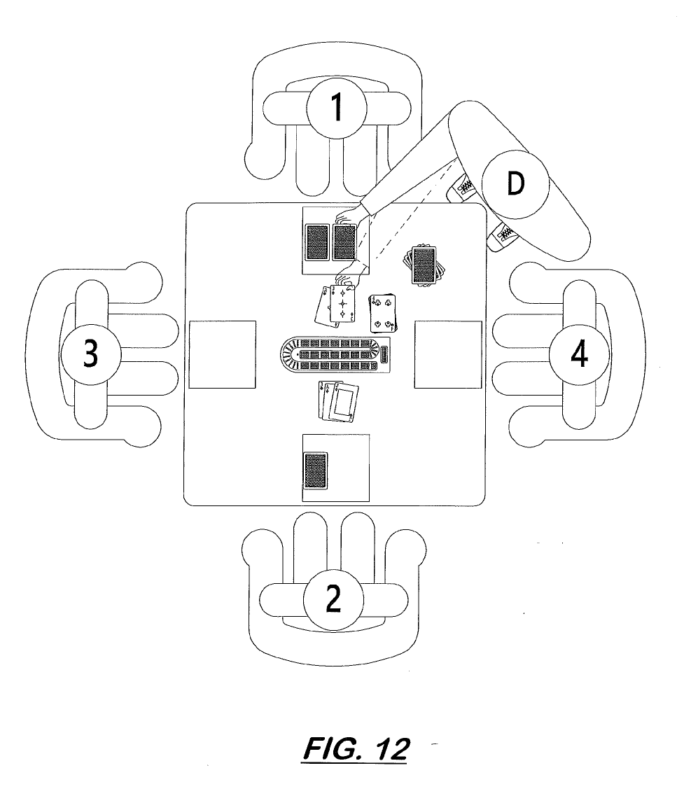

As stated above, the table 12 is setup in a game room 11 that can accommodate a plurality of live or remote players 17AD. Preferably, the table 12 is limited to two to four players. It should be understood however, that the actual number of designated seats 20 A-D is limited only by the size and shape of the table 12 and the limits of game rules. In the preferred embodiment, a live attendant 15 manages the table 12 and physically sits at the designated attendant seat 13. The attendant 15 may manually shuffle a standard set of playing game objects 21 or deal an RFID tag embedded or barcode embedded deck of playing game objects 130. The attendant 15 may use an automatic shuffler. When the attendant 15 distributes the RFID tag embedded game objects 130 to the remote players, be or she passes them over the RFID device 142 located near the attendant 15 or adjacent to the transparent panel 80 at each designated seat as shown in FIG. 7. The attendant 15 then keeps the game object 130 ‘face down’ when moving and placing it onto a glass plate 80 located at each designated seat 20 as shown in FIG. 7. If a standard set of playing game objects 21 and a scanner device 172 are used in place of the game objects 130 and the RFID device 142, then the playing game objects 21 are read by the scanner device 172 as shown in FIG. 11.

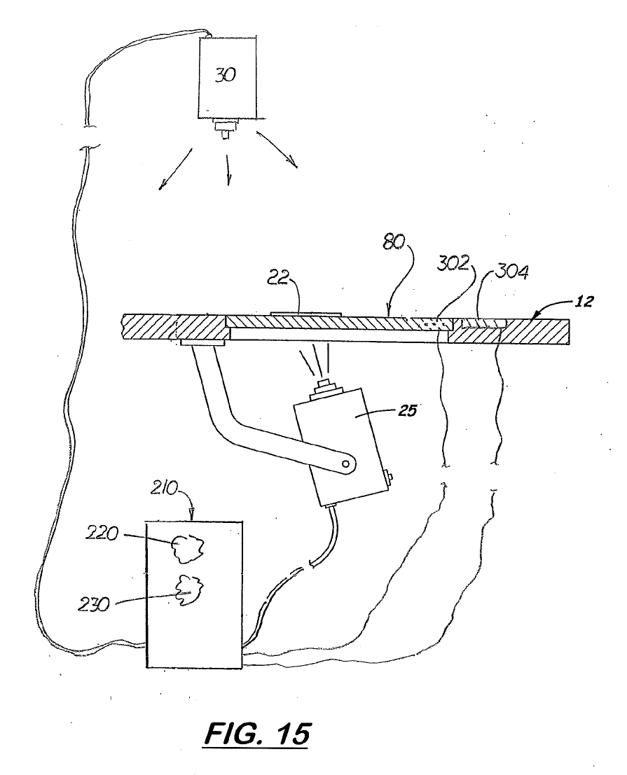

As shown in FIGS. 1 and 15 and described above, a private card camera 25 is positioned at each designated seat. The private card camera 25 is positioned below the table 12 and aimed upward towards a transparent plate 80. When private game objects 22 are placed on the transparent plate 80, the image 26 of the private game objects 22 is transmitted to the remote player's display 101.

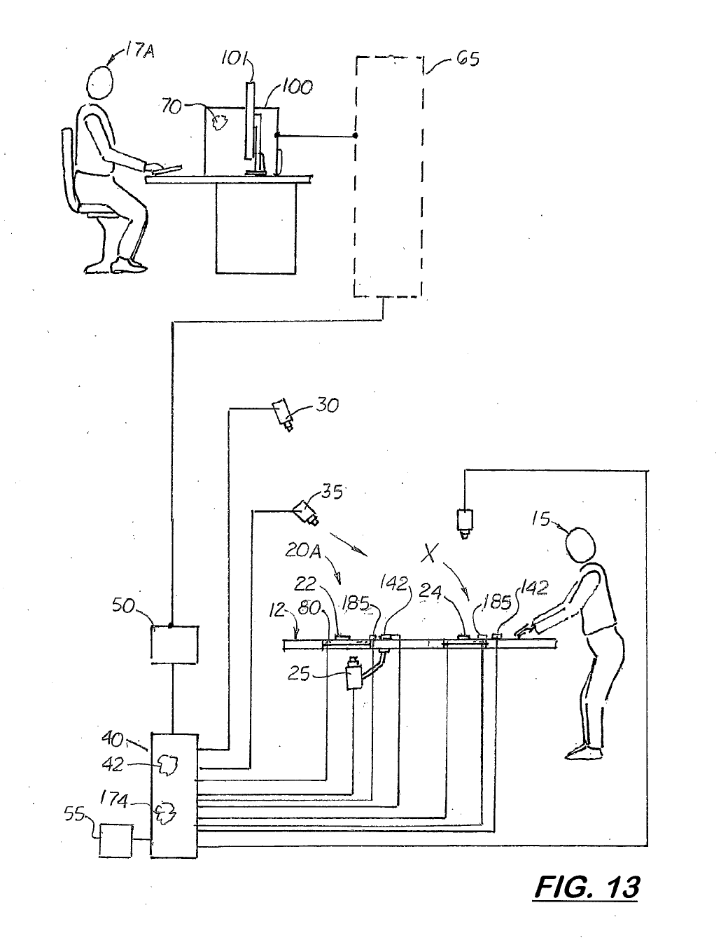

As shown in FIGS. 1 and 13, at least one public camera 30 is located above the table 12 and aimed downward over the table 12 so that all the public game objects 24 dealt face up on the table 12 may be seen are transmitted to the remote player.

Also shown in FIGS. 1 and 13, a table camera 35 used to view the attendant 15, and the designated region “X” on the table 12 where the public game objects 24 are placed. Typically, the designated region “X” is in the central region of the table.

During operation, the table camera 15 is used to create an image showing both the attendant 15 and the designated region “X” which may be transmitted to the remote players.

FIG. 13 also shows a remote player connected via his or her remote computer and a wide area network to the webserver and game server and playing online poker system disclosed herein wherein the images and identities of the public and private game objects are transmitted to the remote player and stored in the game server.

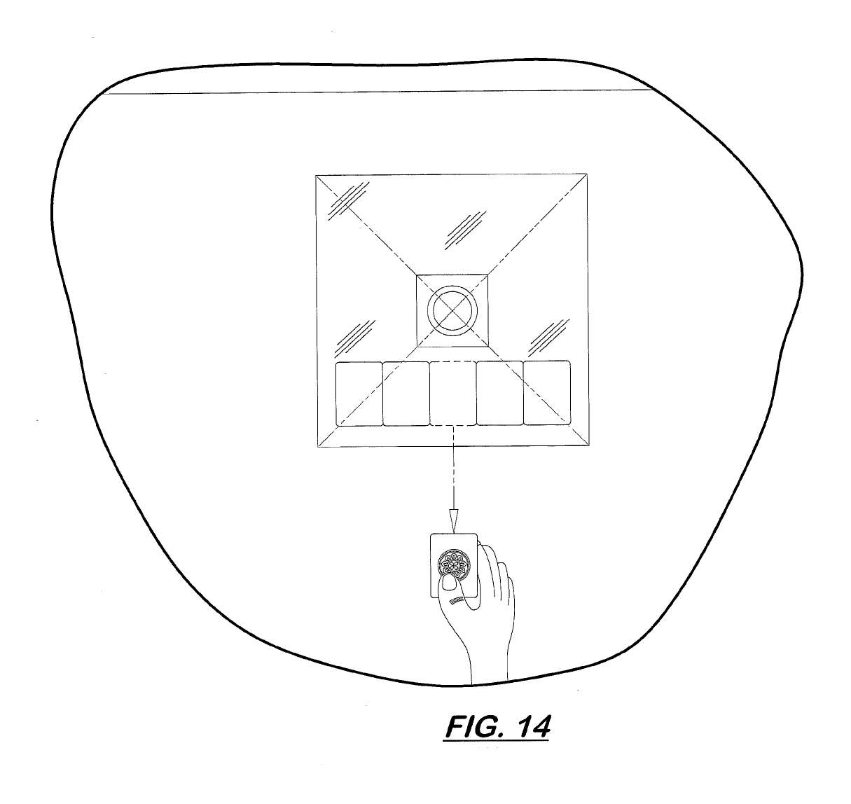

FIG. 14 is a partial top plan view of table showing a modified designated player area that includes a transparent panel and a public camera located under the transparent panel with a RFID antenna constructed in the transparent panel or the table.

FIG. 15 is a partial top plan view of table showing a modified designated player area that includes a transparent panel 80 and a private camera 25 located under the transparent panel 80 with a embedded RFID antenna 302 or embedded barcode reader 304 in the transparent panel 80 or the table 12. The embedded RFID antenna 302 or barcode reader 304 are locate at or near the edge of the transparent panel 80 closest to the attendant 15 so that when the game objects are dealt, the attendant's aim and hand move in a straight line. Also, the creation of the image and the verification and recording the identity of the playing card occur nearly simultaneous.

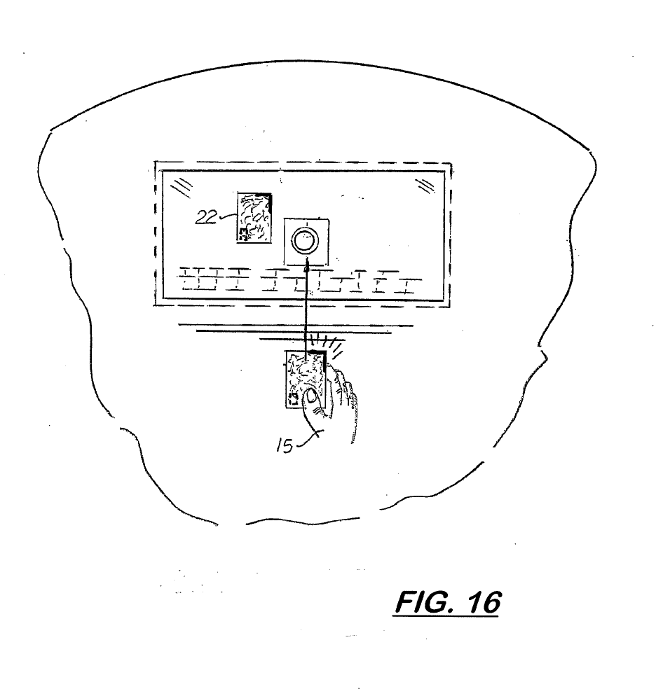

FIG. 16 is a sectional side elevational view of a designated seat showing the location of the transparent panel 80 and the private camera 25 connected to a computer 210 with a barcode reader software program 220 or an OCR software program 230 loaded therein. Like the system shown in FIG. 15, the identity of the card also occurs simultaneously with the image created by the private camera 25.

In one embodiment, each remote player 17A-D accesses the system 10 via opening a client side software program 70 used to connect to the game server 40. The client side software program 70 can be obtained from a game server 40 or one of its licensees. Each remote player's computer 100 must be connected via the wide area network 65 to a secure platform that comprises the outer shell of the gaming platform. In one embodiment, shown in FIG. 1, each computer 100 operated by a remote player 17A-D may be connected to the webserver 50 via a browser software program 71 loaded into the remote computer 100. The browser program 71 may use a plug-in software program 73 that enables the browser program 71 to communicate with the webserver 50 and view webpages and input information. In both scenarios, each remote player 17A-D logs onto the system 10 via a log-on menu 72 as shown in FIG. 3 which requires each remote player to type into his or her personal username and password in the appropriate box 73, 74 respectively.

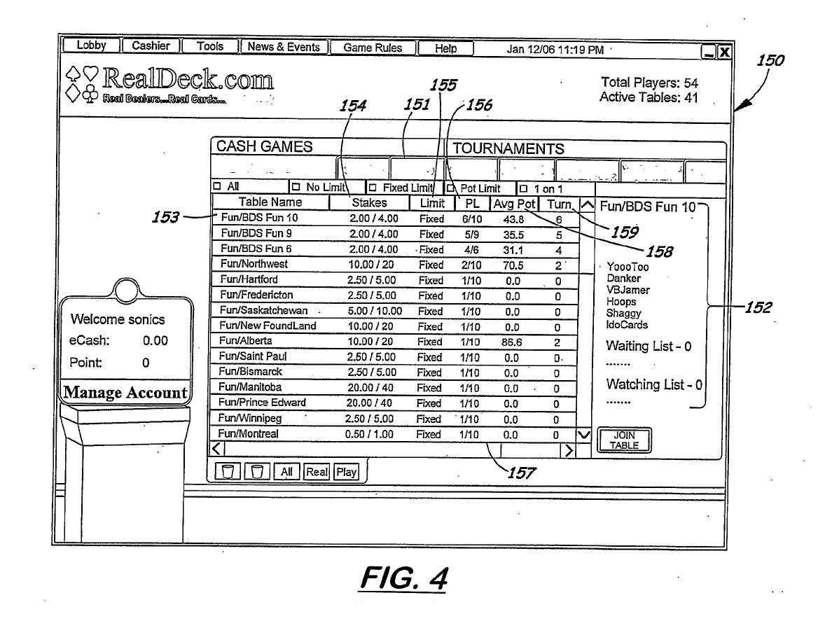

After authenticating the player's username and password, the image of a game menu 150 is presented (see FIG. 4) that presents the types of games 151, a list of all of the games 152 currently available, the name of the tables 153, the stakes 154, the game limit 155, the number of seats at the table 156, current players 157, the average pot size 158, and the next player's in turn indicator 159.

The client side software program 70 or the webpage from the webserver 50 presents a log-on menu 72. When activated and the proper username and password are submitted, the remote player is able to log into the game server 40. After logging into the system 10, a game interface 112 is then presented on the remote player's display 101.

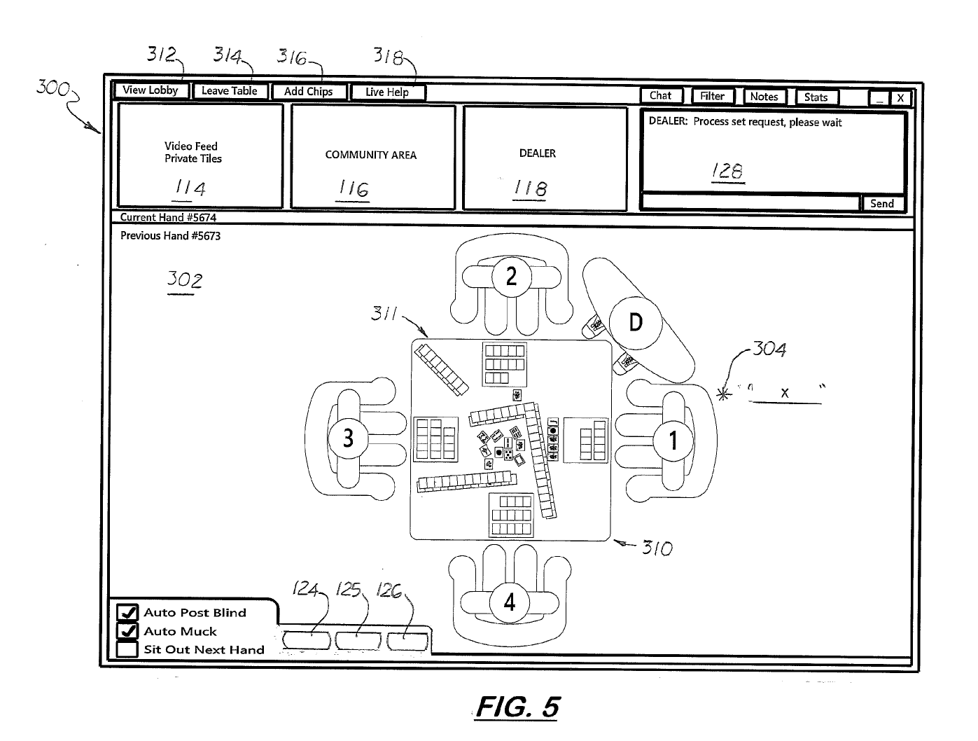

FIG. 5 is an illustration of the game interface 112 presented on the remote player's display showing a game action menu 113. Presented on the game action menu 113 is at least one open seat that the remote player must select before joining the game. In some instances, an open seat may be automatically assigned to the remote player when the remote players select the game from the game menu 150.

When the remote player joins a game, a player information box 302 is presented on the game action menu 300. The player information box 302 includes a visual indicator 304 that when activated, informs the remote player that it is his or her turn to play. As an optional feature, the visual indicator 304 may include a statement to remind the remote player the type of action that be or she has been previously taken.

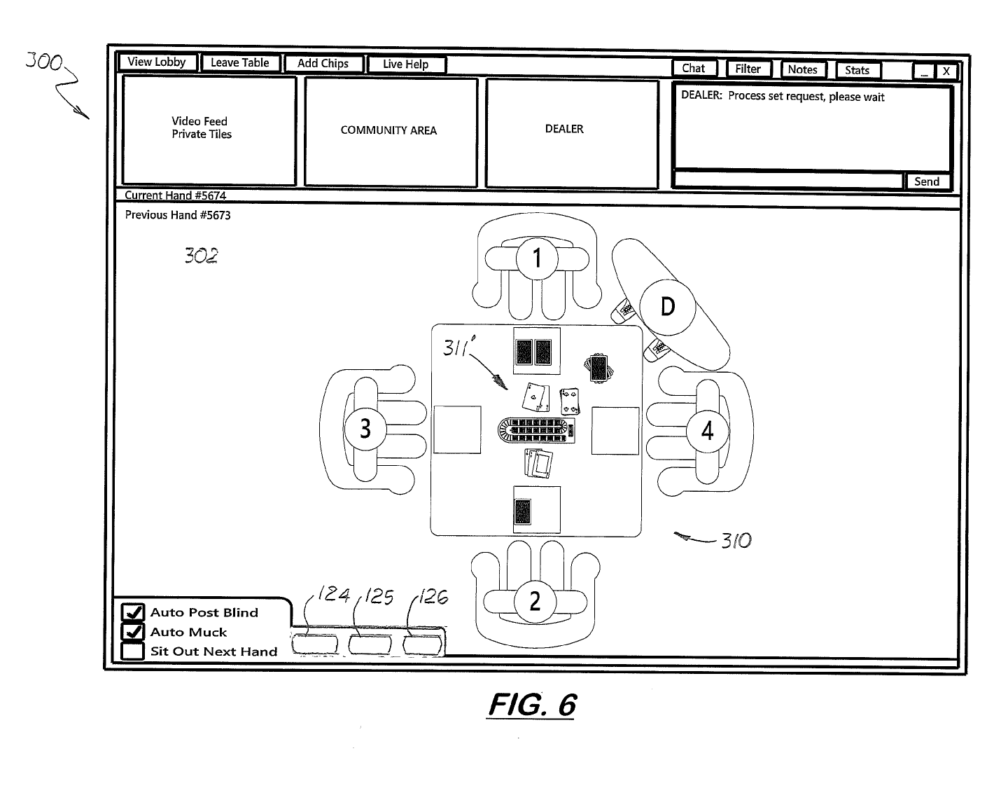

Located on one side of the game action menu 300 is the private game object window 114, a public game object window 116, and a live table window 118 as discussed above. During the course of a game, the live image 26 of the private game to objects 22 dealt to the remote player is shown in the private card window 114. The live image 31 of the public game objects 24 are shown in the public game object window 116. Images 36 of the entire or a portion of the table 12 taken by the table camera 35 are shown in the table view window 118. Simulated images of the public and private game objects along with their descriptive names may be shown in the simulated image of the full table 310. Located on the game action menu 300 is a large simulated image window 302 depicting a game table 310 with designated seats assigned to remote players. FIG. 5 depicts a table 310 showing a Mahjong game 311 and FIG. 6 depicts a table showing a Cribbage game 311′ that includes a Cribbage board, face down cards, and Crib cards on the table.

Located in the upper corner of the game action menu 300 is an optional chat window 128 that allows the attendant, the live players and the remote players to chat during a game. Located along the left upper edge of the game action menu 300 are optional player management buttons 312, 314, 316, 318 that enable the remote player to view the game room lobby menu 150, temporarily leave table, add chips, and request help, respectively. Also, located along the right upper edge of the game action menu 300 is an ancillary window buttons 320, 322, 324, 326 that allow the remote player to chat, filter, take notes or view stats, respectively. Also presented on the game action menu 300 are player control buttons 124, 125, and 126 associated with actions or instructions to the attendant. The nature of actions or instructions associated with the buttons 124, 125, and 126 are dependent on the nature of the game.

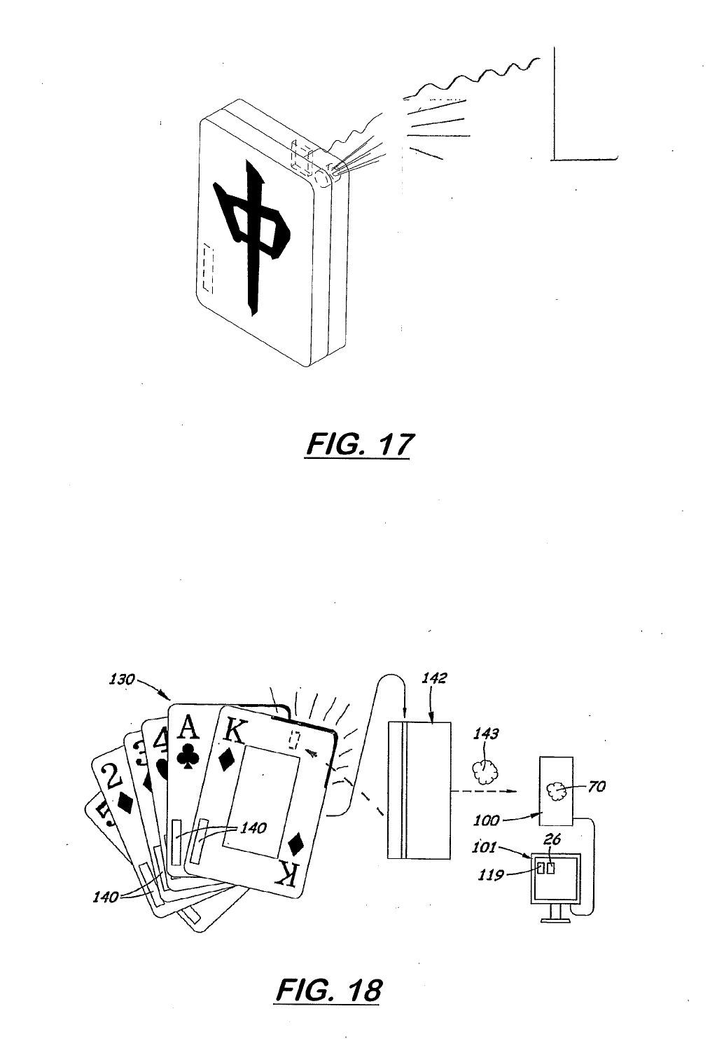

As shown in FIGS. 17 and 18, the game objects 600 include a wireless identifier 700 that can be identified by the system that enables the cards and game objects to be track by the game server. Each game object 600 also includes a wireless to receiver 510, respectively, coupled to a physical signaling element 620, respectively that when activated generates a sound, a light or a vibration detectable by the attendant. When a remote player selects a game object 600 on his display, a signal 800 is sent from the remote player's computer to the game server. The game server then transmits a wireless signal 900 to the wireless receiver 510, 610 built into the game object 600 causing activation of the physical signaling element 620. When detected, the attendant then physically moves the activated game object 610 to the remote player's designated seat location or the discard pile

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

### INDUSTRIAL APPLICABILITY

This invention has application in the gaming industry. More specifically, this invention has application with on-line game industry.

I claim:

1. An on-line game system, comprising:
a. a game room containing a table with designated seats located thereon;
b. at least one attendant assigned to said table, said attendant distributes playing cards or game objects used in a game to designated seats on said table assigned to players physically located at said table or to players remotely located from said remote table;
c. at least two players assigned to said designated seats at said table with at least one player being located at a remote location from said table;
d. a wide area network;
e. a means for imaging face down cards or game objects on said table, said means for imaging face down cards or objects includes a transparent panel located on said table at or near each said designated seat, and a private camera aimed to view the bottom surface of a playing card or a game object placed face down on said transparent panel, said private camera being coupled to said wide area network to transmit an image of the face down cards or game objects placed on said transparent panel only to said remote player assigned to said designated seat;
f. a plurality of playing cards or game objects to play a game with remote players at said table, each said playing card or game object includes a wireless receiver and a physical signaling element;
g. at least one public camera located above said table or at or near each said designated seat used to create and transmit an image of face up cards or game objects distributed on said table;
h. means for verifying the identity of each public card or game object as it is dealt on said table;
i. means for verifying the identity of each said private card or game object as it is dealt on said table;
j. a game server including working memory with at least one game managing software program loaded therein, said game managing software program enabling said game server to act as a state machine to managing a game played to between said players assigned to said designated seats at said table, said game server being connected to said means for verifying the identity of said private cards or game objects and said means for verifying the identity of said public cards or game object so that identity therefore is recorded into a game file, said game server also configured to receive specific card or game object selections from said remote players and transmit a wireless signal to said wireless receiver on said select card or game object to activate said physical signaling element;
k. a web server connected to said wide area network and to said game server;
l. a remote computer operated by said each player at a remote location and assigned to one said designated seat on at said table, said remote computer including working memory, means for connecting said remote computer connected to said wide area network, and a display; and,
m. a game software program used to present the image of a table with designated seats assigned to live or remote players on said display of said remote players assigned to one said designated seat at said table, said game software program also used to present images of face-up playing cards or game objects dealt on said table on said displays operated by all said remote players and to present images of face down playing cards or game objects distributed to said designated seat assigned to said remote player to said display used by said remote player, said game software program also used to receive name instructions from said remote player.

2. The on-line game system, as recited in claim 1, wherein said means for verifying the identity of said face down game objects is an identifying RFID tag located thereon and at least one RFID detecting device used to detect said RFID tag when said game object is swiped through or placed on said RFID detecting device.

3. The on-line game system, as recited in claim 2, wherein said RFID detecting device is located near said attendant to allow said RFID detector to identify said game object as it is moved by the attendant.

4. The on-line game system, as recited in claim 2, wherein said RFID detecting device is located near said transparent panel so that identity of said game object maybe determined simultaneously as said game object is being positioned in a face down position on said transparent panel.

5. The on-line game system, as recited in claim 4, wherein said RFID detecting device is located adjacent to said transparent panel.

6. The on-line game system, as recited in claim 1, wherein said means for verifying the identity of said face down game object is a deck of playing cards with each said card includes a barcode located thereon and at least one barcode reader used to read said barcode when said playing card is passed through said barcode reader.

7. The on-line game system, as recited in claim 6, wherein said barcode reader is located near said attendant and oriented so that said card maybe passed through said barcode reader simultaneously as said card or game object is dealt.

8. The on-line game system, as recited in claim 6, wherein said barcode reader is located near said transparent panel so that identity of said game object maybe determined simultaneously while said game object is being positioned in a face down position on said transparent panel.

9. The on-line game system, as recited in claim 1, wherein said means for verifying the identity of said face down game objects is an OCR software program that uses the images from said private camera or said public camera and sends a description of said private game objects, or said public game object to said display.

10. The on-line game system, as recited in claim 1, further including at least one table camera used to show the image of the face up game objects on said table and said attendant, said table camera being coupled to each said remote computer enabling said players to view said face up game objects and said attendant.

11. The on-line game system, as recited in claim 2, further including at least one table camera used to show the area of said table where said face up game objects are placed and said attendant may be seen, said table camera being coupled to each said remote computer enabling said players to view said face up game objects and said attendant.

12. The on-line game system, as recited in claim 6, further including at least one table camera used to show the area of said table where said face up game objects are place and said attendant may be seen, said table camera being coupled to each said remote computer enabling said remote players to view said face up game objects and said attendant.

13. The on-line game system, as recited in claim 6, further including at least one table camera used to show an image of the face up cards on said table and said attendant, said table camera being coupled to each said remote computer enabling said remote players to view said face up cards or game objects and said attendant.

14. The on-line game system, as recited in claim 1, further including a game interface on said display on said remote computers, said interface presents separate images of face-up cards or game objects on said table from said public card camera, said private card camera and said table camera.

15. The on-line game system, as recited in claim 1, further including a database server connected to said game server, said database server being used to record specific game information.

16. A method for playing on-line game, comprising the following steps:
a. selecting a remote computer using a display, said remote computer able to communicate over a communication network with an on-line game system;
b. connecting said remote computer to a wide area network;
c. connecting said remote computer to an on-line game system connected to said wide area network, said system includes a table with an attendant for dealing who deals playing cards or game objects for the game to be played at said table, said table includes a plurality of designated seats, each said designated seat being assigned to a player located at said table or to a player located at a remote location and connected to said game system using said remote computer, each said designated seat assigned either to a player adjacent to said table or assigned to a player at a remote location, each said designated seat includes a transparent panel located on said table at or near said designated seat and a private camera configured to view the bottom surface of face down game objects dealt onto said transparent panel, said transparent to panel and said private camera located at each said designated seat assigned to a player at a remote location, said system also includes at least one public camera for viewing that views game objects distributed face-up on said table,
means for verifying the identity of each said game object distributed on said table;
means for verifying the identity of each said game object distributed on said table;
said system also includes a game server connected to said wide area network with a game managing software program loaded therein, said game server being connected to said means for verifying the identity of said game objects and said means for verifying the identity of said game objects so that the identity of said game objects and said game objects is recorded into a game file on said game server;
said game managing software program configured to manage a game played at said table with at least one remote player assigned to one said designated seat;
d. logging onto said system using said remote computer and connected to said game server;
e presenting a game interface on said display, said game interface includes the image of a table that shows the location of the plurality of designated seats located thereon, and a plurality of game action buttons used to select different activities during a game, said interface also including designated areas where the images of said private camera and said public cameras are shown, said interface also including areas where the codes or descriptions of said means for verifying said private game objects and said game objects are presented;
f. choosing a designated seat on said table with a plurality of designated seats, at least one said seat being assigned to at least one player located at said table or to a player at a remote location; and,
g. playing a game with the attendant assigned to said table and with a plurality of playing cards or game objects and with one or more other players assigned to another said designated seat at said table, said remote computer used to communicate with said game server to send and receive instructions and data from said game server, said remote computer able to receive images from said public camera to display images of face-up game objects distributed on said table and to receive images from said private camera to obtain images of said face down game objects so as to display the face-down said game objects distributed to said designated seat assigned to said player at said remote location, said remote computer also able to select said game objects on said table and communicate the designed said game object to the attendant and instruct the attendant to more the designated said game object to a designated area on said table, said remote computer able to input game instructions to said game server.

17. A method for playing on-line game, as recited in claim 16, wherein said on-line game system further includes a table camera that transmits an image of the attendant distributing said game objects cards at said table to each said remote computer.
